(19) United States
(12) Patent Application Publication
(10) Pub. No.: US 2016/0161998 A1
(43) Pub. Date: Jun. 9, 2016

(54) Actively Cooled Liquid Cooling System

(71) Applicant: CORSAIR MEMORY, INC., FREMONT, CA (US)

(72) Inventor: Robert Michael Kinstle, III, Livermore, CA (US)

(21) Appl. No.: 14/562,264

(22) Filed: Dec. 5, 2014

(51) Int. Cl. G06F 1/20; F25B 21/02

(52) U.S. Cl. CPC G06F 1/20; F25B 21/02

(57) ABSTRACT

An active cooling system that includes a thermo electric cooler device is used to improve heat transfer from a processor in the computer such that the resulting temperature of the processor in the computer drops below the ambient temperature or the temperature of the cooling liquid that is returning from a heat exchanger.

### TECHNICAL FIELD

The disclosed embodiments relate generally to cooling systems. More particularly, the disclosed embodiments relate to methods, systems for cooling computer processing device.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a high-level block diagram that illustrates the heat transfer from a processor in the computer to the radiator using a TEC device and conductive plates, according to certain embodiments.

FIG. 2 is a high level flow chart that illustrates cooling of computer processors using a TEC device, according to certain embodiments.

### DESCRIPTION OF EMBODIMENTS

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, an active cooling system is used to improve heat transfer from a processor in the computer such that the resulting temperature of the processor in the computer drops below the ambient temperature or below the temperature of the cooling liquid that is returning from a heat exchanger. Non-limiting examples of a processor include CPUs (central processing units) and GPU (graphics processing units).

According to certain embodiments, an active cooling device is used to cool a liquid coolant to a temperature below the temperature of the cooling liquid that is returning from a heat exchanger, such as a radiator, wherein the liquid coolant transfers heat from the processor in the computer The embodiments are not restricted to liquid-to-air radiators as heat exchangers. Other types of heat exchangers can include a liquid-to-liquid heat exchanger. The types of heat exchangers used can vary from implementation to implementation.

According to certain embodiments, the active cooling system includes a thermo electric cooler device (herein referred to as “TEC device”) for cooling the liquid coolant.

According to certain embodiments, the liquid coolant is first chilled by the TEC device before passing to a cold plate associated with a processor in a computer in order to remove heat from the processor in the computer. As a non-limiting example, a processor in the computer can be a central processing unit (CPU) or a graphics processing unit (GPU). The TEC device is cold on one side and hot on the flip side.

According to certain embodiments, the TEC device is placed between two conductive plates for purposes of heat transfer between the TEC device and the liquid coolant. For example, a chiller cold plate is used to remove heat from the liquid coolant and the chiller cold plate conducts the heat into the cold side of the TEC device. The cooled liquid coolant is in turn used to cool a processor in the computer that generates heat. Similarly, a chiller hot plate is used to absorb heat from the hot side of the TEC device in order to transfer the heat away from the TEC device to be dissipated at a radiator, for example.

According to certain embodiments, a controller controls the TEC device to maintain a temperature difference between the cold side and the hot side of the TEC device such that the temperature difference is within a range that is suitable for optimal operating efficiency of the TEC device. According to certain embodiments, such a temperature difference is in the 20 degree Celsius range. Further, the TEC device is not placed directly on the heat generating processor in the computer because, by doing so, requires the TEC device to transfer 100% of the heat generated by the processor in the computer. Such a heat load is beyond the capacity of all but the highest performing TEC devices.

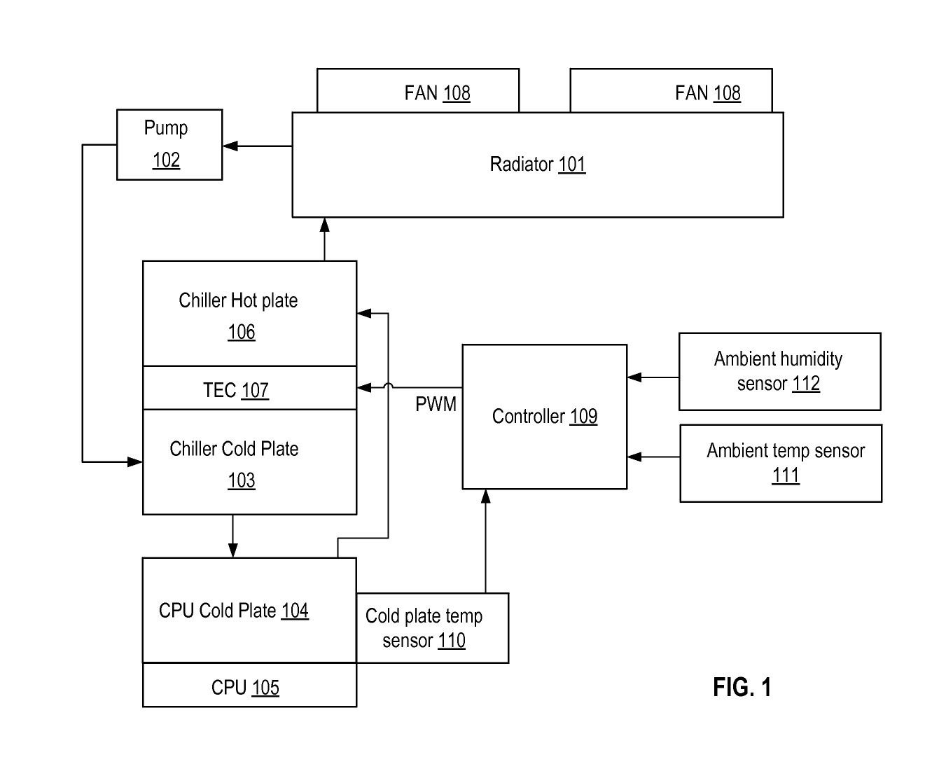

FIG. 1 is a high-level block diagram that illustrates the heat transfer from a processor in the computer to a radiator using a TEC device and conductive plates, according to certain embodiments. For purposes of explanation, a processor in the computer is also referred to as processing device.

FIG. 1 shows a radiator 101, one or more radiator fans 108, a pump 102, a TEC device 107, a chiller cold plate 103, a chiller hot plate 106, a processor in the computer 105, a cold plate 104 for the processor in the computer (for example, a CPU chiller cold plate), a controller 109, an ambient humidity sensor 112 and an ambient temperature sensor 111. Such sensors are located in suitable positions that allow for sensing of the ambient conditions of the environment. Further, cold plate 104 is associated with a cold plate temperature sensor 110. Non-limiting examples of a processor in the computer 105 include CPUs (central processing units) and GPUs (graphics processing units). The embodiments are not restricted to CPUs or GPUs. For ease of explanation, assume that the processor in the computer 105 in FIG. 1 is a CPU.

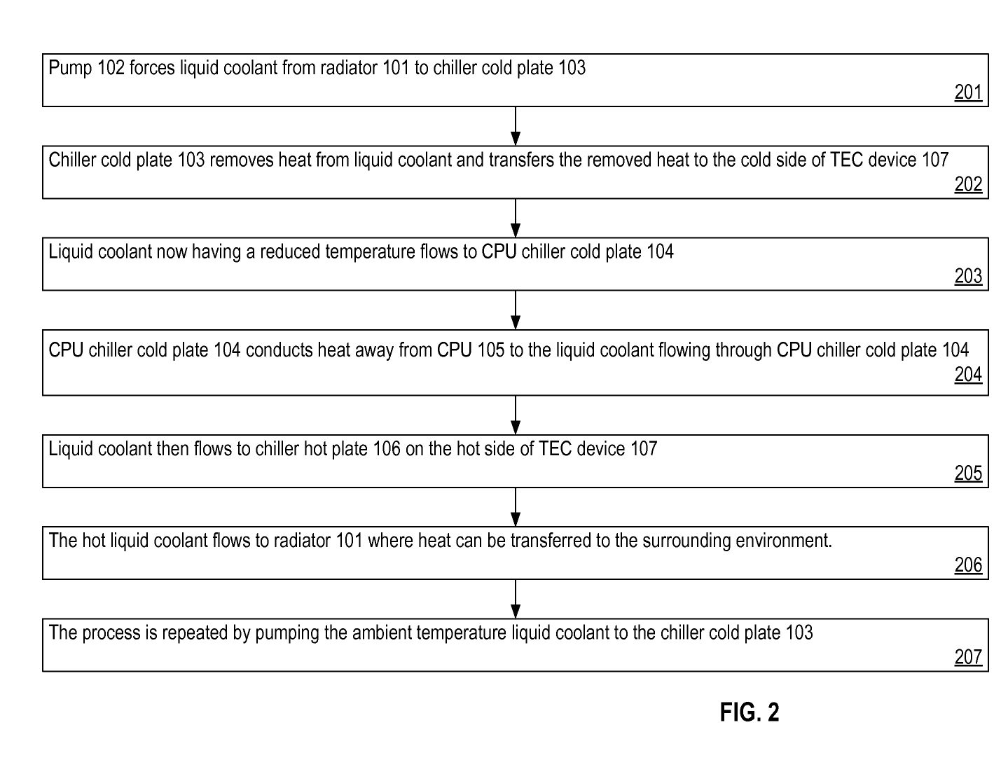

FIG. 2 is a high level flow chart that illustrates cooling of computer processors using a TEC device, according to certain embodiments. According to certain embodiments, at block 201, pump 102 forces liquid coolant from radiator 101 through tubing to chiller cold plate 103.

At block 202 of FIG. 2, chiller cold plate 103 is a conductor that removes heat from the liquid coolant and transfers the removed heat to the cold side of TEC device 107, thereby cooling the liquid coolant below the ambient temperature of the environment, or at least below the temperature of the cooling liquid that is returning from a heat exchanger. The TEC device 107 is also known as a Peltier junction. According to certain embodiments, controller 109 controls the operation of TEC device 107 such that the temperature difference between the cold side and the hot side of the TEC device is in the range of about 0-20 degree Celsius as described in greater detail below.

At block 203 of FIG. 2, the liquid coolant now having a temperature reduced to below the ambient temperature or at least below the temperature of the cooling liquid that is returning from a heat exchanger flows into the CPU chiller cold plate 104.

At block 204 of FIG. 2, CPU chiller cold plate 104 conducts heat generated by CPU 105 away from CPU 105 to the liquid coolant flowing through the CPU chiller cold plate 104, thus raising the temperature of the liquid coolant.

At block 205 of FIG. 2, the liquid coolant then flows to chiller hot plate 106 on the hot side of the TEC device 107. The liquid coolant absorbs the heat released from the hot side of TEC device 107.

At block 206 of FIG. 2, the now hot liquid coolant flows to radiator 101, where heat can be transferred from the liquid coolant to the surrounding environment with the help of the one or more fans 108. Thus, the temperature of the liquid coolant is returned to ambient temperature or close to ambient temperature.

At block 207 of FIG. 2, the process repeated by pumping the ambient temperature liquid coolant through tubing to the chiller cold plate 103, as described above.

According to certain embodiments, the hot and cold plates such as chiller hot plate 106, chiller cold plate 103 and the CPU chiller cold plate 104 are made of a thermally conductive material. According to certain embodiments, a given hot or cold plate is flat on one side and includes fin structures on the flip side of the plate where the fin structures form channels through which liquid coolant can flow and thereby enable heat exchange between the plates and the liquid coolant. The flat side of the plate makes contact with either a hot or cold surface (e.g., surface of CPU or a surface of the TEC device).

According to certain embodiments, non-limiting examples of thermally conductive material of the plates are copper or aluminum. The fin structures may be cast, mechanically machined, extruded, electrical discharge machined (EDM), or skived. As another example, the hot or cold plate can include pins instead of fin structures. In the case of a plate using pins, there are channels on the plate for routing the liquid coolant through the surface of the plate.

According to certain embodiments, controller 109 enables high performance of the system while preventing condensation in the computer case where the CPU resides. According to certain embodiments, controller 109 obtains information on ambient temperature from ambient temperature sensor 111, and information on ambient humidity from the ambient humidity sensor 112. The controller calculates the dew point (herein referred to as the “calculated dew point”) based on the ambient temperature and ambient humidity information from sensors 111 and 112. Controller 109 drives a pulse width modulated (PWM) output into a transistor switch or H bridge amplifier, which drives main power to TEC device 107 that is modulated to the selected duty cycle. In other words, the controller uses the PWM to control the supply of power to TEC device 107.

Controller 109 obtains temperature information of the CPU chiller cold plate 104 from cold plate temperature sensor 110 and drives TEC device 107 to maintain the temperature of CPU chiller cold plate 104 to be slightly higher than the calculated dew point to prevent condensation at the CPU and other parts of the computer.

Controller 109 may include a data interface for communication with a host computer. Controller 109 operates independently of the host computer. However, the parameters of controller 109 can be modified by the host computer.

According to certain embodiments, controller 109 may adjust the speed of radiator fans 108 to regulate airflow through the radiator based on the cooling demands of the system.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A system for cooling a computer, the system comprising:
a thermo electric cooler device having a hot side and a cold side;
a processing device;
a first chiller cold plate for removing heat from a liquid coolant;
a second cold plate for transferring heat from the processing device to the liquid coolant; and
a third cold plate for transferring heat from the thermo electric cooler device to the liquid coolant.

2. The system of claim 1, wherein,
a flat surface of the first chiller cold plate is in contact with the cold side of the thermo electric cooler device;
a flat surface of the second chiller cold plate is in contact with the processing device; and
a flat surface of the third chiller cold plate is in contact with the hot side of the thermo electric cooler device.

3. The system of claim 1, further comprising at least one ambient humidity sensor for sensing ambient humidity and at least one ambient temperature sensor for sensing ambient temperature.

4. The system of claim 1, further comprising at least one controller for calculating an ambient dew point based on ambient humidity information and ambient temperature information.

5. The system of claim 1, further comprising at least one controller for controlling the thermo electric cooler device, which in turn maintains the second cold plate at a temperature above ambient dew point.

6. The system of claim 5, wherein the at least one controller drives a pulse width modulated output for controlling a supply of power to the thermo electric cooler device.

7. The system of claim 1, further comprising at least one heat exchanger, the at least one heat exchanger including one or more fans for transferring heat from the liquid coolant.

8. The system of claim 1, wherein each of the first, second and third chiller cold plates is made of a thermally conductive material and includes channels on one surface for routing the liquid coolant through the one surface.

9. The system of claim 4, further comprising a data interface for communication between the at least one controller and a host computer.
